(19) United States
(12) Patent Application Publication
(10) Pub. No.: US 2012/0241089 A1
(43) Pub. Date: Sep. 27, 2012

(54) METHOD AND APPARATUS FOR THERMOCOUPLE INSTALLATION OR REPLACEMENT IN A SUBSTRATE SUPPORT

(75) Inventors: Joerg Dielmann, Dresden (DE); Reiner Ruediger, Freiberg (DE)

(73) Assignee: APPLIED MATERIALS, INC., Santa Clara, CA (US)

(21) Appl. No.: 13/360,219

(22) Filed: Jan. 27, 2012

Related U.S. Application Data
(60) Provisional application No. 61/467,928, filed on Mar. 25, 2011.

(51) Int. Cl. B44C 1/22; B05C 11/00; B05C 13/00; B23P 19/00

(52) U.S. Cl. 156/345.27; 29/700; 118/666; 118/712

(57) ABSTRACT

An apparatus and method for one or more externally mounted temperature sensors in a substrate support utilized in a chemical vapor deposition (CVD) chamber is provided. In one embodiment, a substrate support for a vacuum chamber is provided. The substrate support comprises a body having a substrate receiving surface and an opposing bottom surface, a support stem coupled to and extending away from the bottom surface, one or more thermal control devices embedded within the body, at least one temperature sensor interfaced with the bottom surface of the body, and a removable hermitic enclosure fastened to the second side of the body and covering the at least one temperature sensor.

### CROSS-REFERENCE TO RELATED APPLICATIONS

This application claims benefit of U.S. Provisional Patent Application Ser. No. 61/467,928 (Attorney Docket No. 11673USAL), filed Mar. 25, 2011, which is hereby incorporated by reference herein.

### BACKGROUND OF THE INVENTION

1. Field of the Invention

Embodiments of the present invention generally relate to substrate supports having thermocouples for use in vacuum processing chambers, such as chemical vapor deposition (CVD) chambers, physical vapor deposition (PVD) chambers, etch chambers and plasma treatment chambers, among others.

2. Description of the Related Art

CVD is a process whereby a gas is introduced into a vacuum chamber to deposit a material layer onto a substrate. The gas may be dissociated prior to deposition on the substrate by dissociating the gas thermally and/or igniting the gas into a plasma (i.e., a PECVD process). There are many applications for utilizing a CVD or a PECVD process such as to deposit layers for a flat panel display (FPD), to deposit layers for a solar panel and to deposit layers for an organic light emitting display (OLED) to name a few.

CVD chambers include a substrate support for supporting a substrate during deposition. The substrate support typically includes a means for thermal control (i.e., heating and/or cooling) disposed within or in proximity a body of the substrate support. The thermal control means is utilized to control the temperature of the substrate before, during, or after processing. Thus, monitoring the temperature of the substrate support is important in order to control the temperature of the substrate. One way to monitor the temperature of the substrate support is to use one or more temperature monitoring devices, such as a thermocouple, that are embedded within the body of the substrate support. The thermocouples are embedded such that vacuum is not compromised within the vacuum chamber. For example, the thermocouples and associated wiring are mounted through internal holes and passages formed within the body of the substrate support.

However, thermocouples are subject to failure and require replacement during predetermined preventative maintenance operations. The embedded thermocouples are difficult to access as portions of the body of the substrate support must be removed by drilling or gouging to expose the thermocouple. The removal of material takes substantial time which causes increased downtime of the CVD chamber. Replacement is also difficult as the wiring and mounting of a new thermocouple takes substantial time. All of these operations cause considerable downtime of the CVD chamber when one or more of the thermocouples need to be replaced. Substrate supports utilized in other types of vacuum chambers have the same problem.

Thus, there is a need in the art to for a method and apparatus that facilitates easy access and replacement of thermocouples within a substrate support for use in a vacuum chamber.

### SUMMARY OF THE INVENTION

The present invention generally relates to monitoring conditions in a chemical vapor deposition (CVD) chamber for processing substrates in the manufacture of flat-panel displays, light emitting diodes, or solar cells. In one aspect, a substrate support is provided having one or more externally mounted temperature sensors is provided. In another aspect, a method and apparatus for installing temperature sensors in a substrate support utilized in the CVD chamber is provided. The one or more temperature sensors may comprise a process kit for a new substrate support or a retrofit for a used substrate support.

In one embodiment, a substrate support for a vacuum chamber is provided. The substrate support comprises a body having a substrate receiving surface and an opposing bottom surface, a support stem coupled to and extending away from the bottom surface, one or more thermal control devices embedded within the body, at least one temperature sensor interfaced with the bottom surface of the body, and a removable hermitic enclosure fastened to the second side of the body and covering the at least one temperature sensor.

In another embodiment, a substrate support for a vacuum chamber is provided. The substrate support comprises a body having a substrate receiving surface and an opposing bottom surface, a support stem coupled to and extending away from the bottom surface, and a plurality of exterior mounted thermal monitoring assemblies disposed on the bottom surface of the body.

In another embodiment, a method for installing one or more temperature sensors in a substrate support suitable for use in a vacuum chamber is provided. The method comprises cleaning the substrate support, drilling a blind hole in a bottom surface of the substrate support, placing a probe of a temperature sensor in the opening, and installing a cover over the temperature sensor, wherein the cover seals the temperature sensor in a volume that is isolated from the environment exterior of the cover and the volume is in fluid communication with an annulus of a support stem coupled to the body.

In another embodiment, a process kit for use in a vacuum chamber is provided. The process kit comprises one or more temperature probes, one or more housings adapted to contain at least a portion of one of the one or more temperature probes, one or more conduits. Each of the one or more conduits comprise a fitting at a first end thereof, and a fitting at a second end thereof for coupling to one of the one or more housings, and one or more straps for coupling to the one or more conduits.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only selected embodiments of this invention and are not to be considered limiting of its scope, for the invention may admit to other equally effective embodiments.

FIG. 1 is a side cross-sectional view of one embodiment of a substrate support disposed in an exemplary vacuum chamber.

FIG. 2A is a bottom plan view of the substrate support of FIG. 1 with the support stem shown in cross-section.

FIG. 2B is an enlarged plan view of a portion of the support stem and a conduit of FIG. 2A showing one embodiment of a first coupling interface.

FIG. 3 is a partial enlarged view of the support stem of FIG. 2A illustrating another embodiment of a first coupling interface.

FIG. 4 is a side cross-sectional view of a portion of an exterior mounted thermal monitoring assembly coupled to the substrate support of FIG. 1 showing another embodiment of a second coupling interface.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

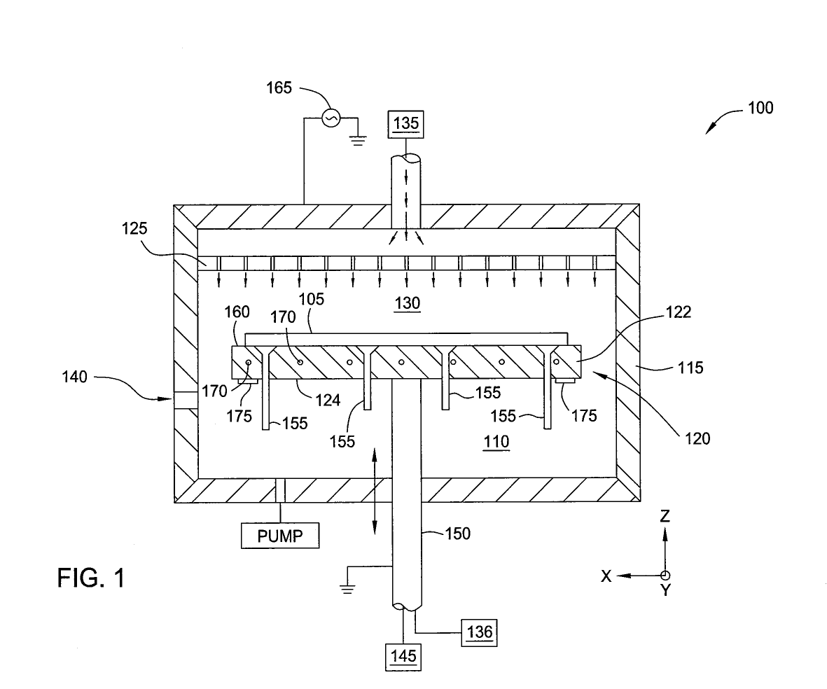

FIG. 1 is a side cross-sectional view of one embodiment of a vacuum chamber 100 suitable for processing substrates, such as wafers or flat media, in the manufacture of flat panel displays, solar panels, light emitting diodes (LEDs) or other electronic devices. For the sake of brevity and not by way of limitation, the vacuum chamber 100 is illustrated as a plasma enhanced chemical vapor deposition (PECVD) chamber. Embodiments described herein may also be utilized in vacuum chambers configured for other processes, such as physical vapor deposition (PVD) processes, etch processes, or other vacuum process on a substrate or multiple substrates. In addition, the vacuum chamber 100 may be a stand-alone chamber, an in-line chamber, a cluster tool chamber, or some combination or variation thereof.

The vacuum chamber 100 is configured to receive a substrate 105 within an evacuable processing volume 110 defined inside walls of the vacuum chamber 100. The vacuum chamber 100 includes a chamber body 115 containing the evacuable processing volume 110. The evacuable processing volume 110 includes a substrate support 120. The substrate support 120 has a body 122, which has a substrate receiving surface 160 to support the substrate 105 and a bottom surface 124. A gas distribution plate, such as a showerhead 125, is also disposed within the evacuable processing volume 110 in an opposing relationship to the substrate support 120. A processing region 130 is defined in the evacuable processing volume 110 between the showerhead 125 and the substrate 105. The showerhead 125 facilitates dispersion of process gases from a gas source 135 into the processing region 130.

In operation, the substrate 105 is transferred by a robot into the evacuable processing volume 110 through a sealable port 140. The substrate support 120 is coupled to an actuator 145 by a support stem 150. A plurality of lift pins 155 are movably disposed through the substrate support 120 to facilitate transfer of the substrate 105. The actuator 145 is operable to move the substrate support 120 at least in a vertical direction (Z direction) to facilitate placing the substrate 105 on the substrate receiving surface 160.

One or more process gases from the gas source 135 flow into the processing region 130 through openings in the showerhead 125. The process gases may be dissociated and are deposited on an upper surface of the substrate 105 to form the basis of electronic devices. The electronic devices may be thin-film transistors (TFT's), light emitting diodes (LEDs), organic light emitting diodes (OLED's), solar cells, or other electronic devices. In one embodiment, the showerhead 125 may be coupled to a power source 165, such as a radio frequency (RF) power source, to facilitate formation of a plasma of the process gases. Alternatively or additionally, the substrate 105 may be heated to facilitate dissociation of the process gases and deposition of materials thereon. In one embodiment, the substrate support 120 includes an integral thermal control device 170, such as a resistive heater and/or conduits for flowing a heat transfer fluid.

During processing, temperature of the substrate 105 is one of the important process controls utilized for the reliable fabrication of the structures used to form the electronic devices. The body 122 of the substrate support 120 may be made of a thermally conductive material, such as aluminum. The temperature of the substrate support 120 is thus indicative of the temperature of the substrate 105. Therefore, monitoring of the temperature of the substrate 105 may be facilitated by monitoring the temperature of the substrate support 120.

In order to facilitate temperature monitoring of the substrate support 120, one or more temperature sensors 175 are coupled to a bottom surface 124 of the substrate support 120. Each of the one or more temperature sensors 175 are in communication with a controller 136 through signal leads that are contained within the support stem 150. Each of the temperature sensors 175 provide a metric indicative of temperature (i.e., temperature data) of the substrate support 120 to the controller 136. The controller 136 processes the temperature data and provides adjustment of the thermal control device 170 to adjust the temperature of the substrate support 120 and maintain a desired temperature profile.

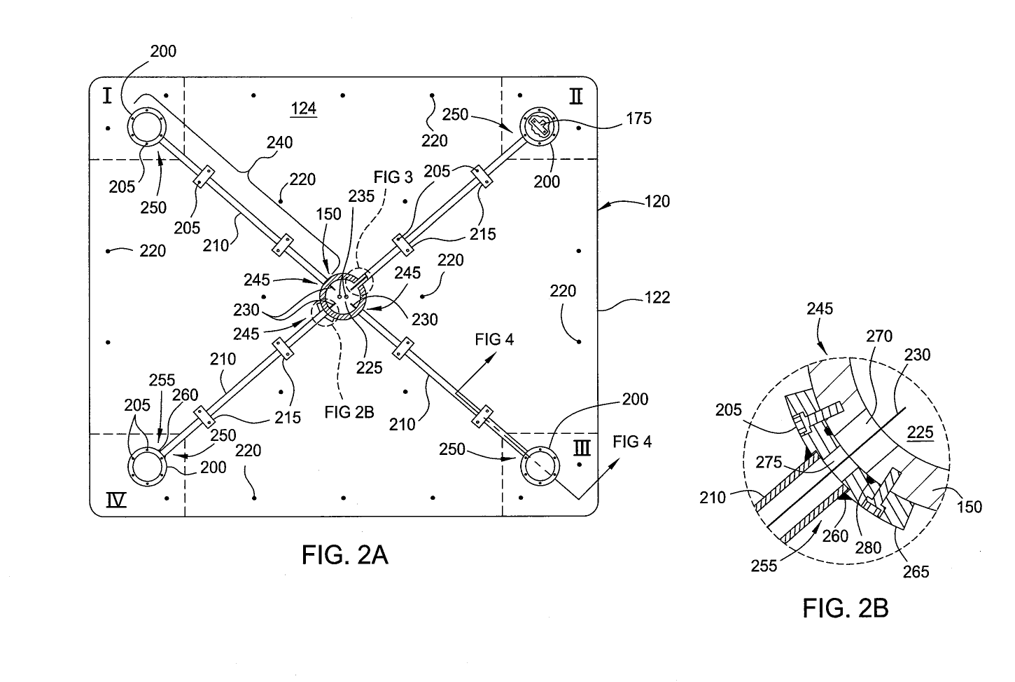

FIG. 2A is a bottom plan view of the substrate support 120 of FIG. 1. In this embodiment, the substrate support 120 is partitioned into corner regions I-IV which indicate the location of temperature probes, such as the temperature sensors 175. The corner regions I-IV shown indicate an area of the body of the substrate support 120 where temperature monitoring is desired. Temperature measurement may be desired and implemented in regions of the body of the substrate support 120 other than the corner regions I-IV but are not shown to avoid drawing clutter. For example, a temperature sensor 175 may be mounted near the center of the bottom surface 124. Each corner region I-IV may comprise a surface area of the bottom surface 124 of the substrate support 120. In one embodiment the surface area of each of the corner regions I-IV is about one-third of the surface area of the bottom surface 124, or less, such as about one-fourth of the surface area of the bottom surface 124, for example, about one-eighth of the surface area of the bottom surface 124.

Within each corner region I-IV, a cover 200 is attached to the bottom surface 124 of the substrate support 120 by fasteners 205. Each of the covers 200 include an interior volume that houses a temperature sensor 175 (only one is shown in the cutaway in corner region II). Each of the covers 200 are coupled to a conduit 210 that extends between the cover 200 and the support stem 150. The conduits 210 may comprise a flexible or rigid tubular member that is coupled to the substrate support 120 by fastening devices 215, such as clips or straps. In one embodiment, the conduit 210 is a tube or a hose comprising a metallic material, such as aluminum. The fastening devices 215 are coupled to the substrate support 120 by fasteners 205. The substrate support 120 also includes a plurality of through-holes 220 formed between the substrate receiving surface 160 (shown in FIG. 1) and the bottom surface 124. Each of the through-holes 220 may comprise bushings adapted to receive and facilitate movement of a lift pin 155 (shown in FIG. 1). Each of the conduits 210 and the covers 200 are coupled to the substrate support 120 in a manner that does not cover a through-hole 220 and/or interfere with operation of the lift pins 155. Thus, while the conduits 210 are shown in a straight line, the conduits 210 may include bends, curves or multiple joints in order to not limit movement or otherwise interfere with the operation of the lift pins 155.

In one embodiment, the support stem 150 is a tubular member having an annulus 225. The annulus 225 serves as a conduit for wiring, control cables, and/or tubular members, to facilitate operation of components disposed within or on the substrate support 120. For example, the annulus 225 contains cables 230 that facilitate communication between the temperature sensors 175 and the controller 136 (shown in FIG. 1). The annulus 225 may also contain thermal control conduits 235 to facilitate operation of the thermal control device 170 (shown in FIG. 1). The thermal control conduits 235 may be wires or cables adapted to control the temperature of the thermal control device 170. Alternatively, the thermal control conduits 235 may be conduits adapted to flow a fluid, such as a gas or liquid, that is utilized in cooling or heating of the substrate support 120.

In one embodiment, each of the covers 200, the temperature sensors 175 and conduits 210 are configured as a process kit comprising one or more exterior mounted thermal monitoring assemblies 240. The process kit may also comprise the fastening devices 215 and fasteners 205. In one aspect, the substrate support 120 comprises a plurality of exterior mounted thermal monitoring assemblies 240 that are coupled to the bottom surface 124. In one embodiment, the exterior mounted thermal monitoring assemblies 240 are disposed radially from a center of the substrate support 120. In another embodiment, the covers 200 (having temperature sensors 175 therein) are substantially equally spaced apart at each corner region I-IV.

During operation, the substrate support 120 is disposed in the evacuable processing volume 110 (shown in FIG. 1) which may be evacuated to about 0.1 milliTorr to about 100 Torr during processing. The annulus 225 of the support stem 150 provides a path for the cables 230 and thermal control conduits 235 to couple with the controller 136 and other components outside of the evacuable processing volume 110. Thus, the annulus 225 is maintained at ambient pressure and the exterior mounted thermal monitoring assemblies 240 coupled thereto must be hermetically sealed to prevent leakage into the annulus 225. The term “hermetic” or “hermetically” refers to a seal, bond or an enclosure utilizing a seal or bond, whether temporary or permanent, that facilitates isolation of one environment from another environment.

In one embodiment, each of the plurality of exterior mounted thermal monitoring assemblies 240 include a first coupling interface 245 between the conduit 210 and the support stem 150, and a second coupling interface 250 between the conduit 210 and the cover 200. In one aspect, at least one of the first coupling interface 245 and second coupling interface 250 comprises a fused joint 255, that may be formed by welding, soldering or brazing. In one embodiment, the fused joint 255 comprises a weld 260 (shown in corner region IV).

FIG. 2B is an enlarged plan view of a portion of the support stem 150 and a conduit 210 of FIG. 2A showing one embodiment of a first coupling interface 245. The first coupling interface 245 comprises a plate 265 that is joined to the conduit 210 by a weld 260. The plate 265 may be formed from a metallic material, such as aluminum. The plate 265 may also be formed on a radius that substantially equals the outside diameter of the support stem 150. The plate 265 may be coupled to the support stem 150 by a plurality of fasteners 205, such as bolts or screws. To facilitate routing of the cable 230 to the annulus 225, an opening 270 may be formed in the support stem 150 by drilling. The plate 265 also includes an opening 275 that facilitates a path for the cable 230 from the conduit 210 to the opening 270 and into the annulus 225 of the support stem 150. Holes for the fasteners 205 may also be drilled into the support stem 150 or the fasteners 205 may be self-drilling/self tapping screws. A seal 280, such as an o-ring or gasket, may be sandwiched between the outer surface of the support stem 150 and the plate 265. The seal 280 is compressed when the fasteners 205 are tightened against the support stem 150 to seal the openings 270 and 275.

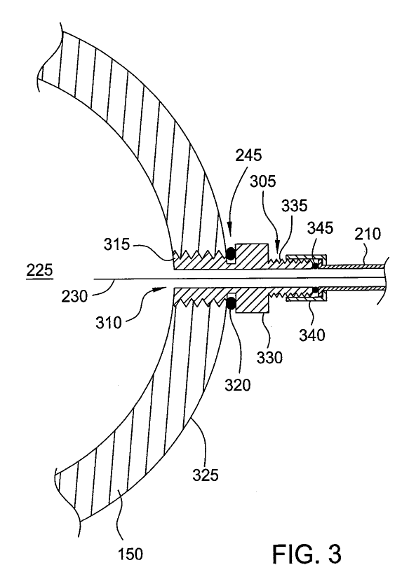

FIG. 3 is an enlarged view of one embodiment of a first coupling interface 245 between the support stem 150 and the conduit 210 of FIG. 2A. The first coupling interface 245 comprises a fitting 305 that facilitates sealable coupling between the conduit 210 and the support stem 150. The fitting 305 may be a nipple, a union or other plumbing device having an internal cavity formed therein. The fitting 305 may be welded, pressed, or otherwise joined to the support stem 150 in a manner that facilitates access to an opening 310 formed in a wall of the support stem 150. The opening 310 may be formed by drilling. The fitting 305 may be bonded or joined to the support stem 150 in a manner that facilitates a hermetic seal.

In one embodiment, the fitting 305 is coupled to the support stem 150 by a threaded connection 315. The opening 310 may be formed by drilling and/or tapping to form threads in the wall of the support stem 150. The threaded connection 315 may include tapered threads that facilitate vacuum sealing at the interface between the fitting 305 and the support stem 150. Alternatively or additionally, a seal 320, such as an o-ring or gasket, may be compressed between an outer surface 325 of the support stem 150 and a body 330 of the fitting 305. The exterior of the body 130 may also include flats (not shown) to facilitate holding and/or rotation of the fitting 305 while making the threaded connection 315. The conduit 210 may be integrated with the fitting 305 prior to coupling with the support stem 150. Alternatively, the conduit 210 may be sealingly coupled to the fitting 305 by welding or other bonding method that facilitates hermetic sealing of an interior region of the conduit 210.

In one embodiment, the conduit 210 couples to the fitting 305 by a threaded connection 335. In one aspect, the conduit 210 includes a ferrule 340 that interfaces with the threaded connection 335. The threaded connection 335 may include tapered threads that facilitate hermetic sealing of the ferrule 340 and the conduit 210 with the fitting 305. Alternatively or additionally, seals 345, such as an o-ring or gasket, may be compressed between surfaces of the fitting 305 and the conduit 210.

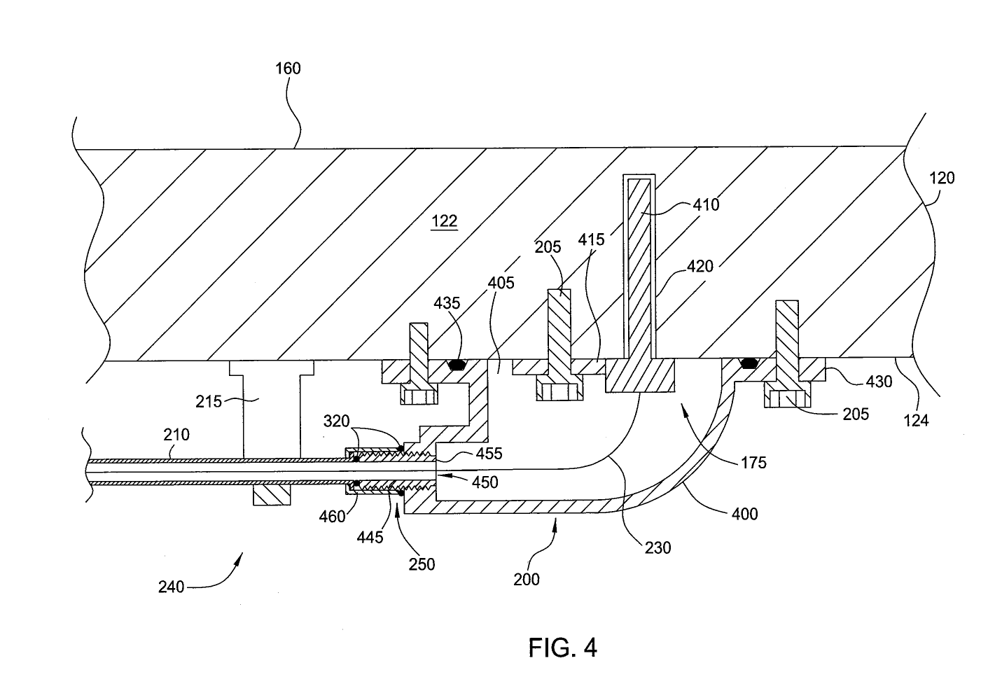

FIG. 4 is a side cross-sectional view of a portion of an exterior mounted thermal monitoring assembly 240 of FIG. 2A. The cover 200 of the exterior mounted thermal monitoring assembly 240 is configured as a hermetic enclosure 400 having an interior volume 405. The interior volume 405 houses at least a portion of a temperature sensor 175. The temperature sensor 175 comprises a probe 410 and a mounting portion 415. The probe 410 is disposed in an opening 420 that may be pre-formed in the bottom surface 124 of the body 122 of the substrate support 120. Alternatively, the opening 420 may be formed in a retrofit operation, such as by drilling. The mounting portion 415 may be secured to the body 122 by a fastener 205. The fastener 205 may be disposed in a pre-formed hole in the body 122 or the hole may be drilled and tapped in the body 122 by personnel in a retrofit operation. The hermetic enclosure 400 is adapted to be removable to access the temperature sensor 175 to facilitate inspection or replacement. The hermetic enclosure 400 comprises a flange 430 having holes formed therein to facilitate hermetic coupling to the body 122. A seal 435, such as an o-ring or gasket, may be disposed between the flange 430 and the bottom surface 124 of the substrate support 120 to facilitate hermetic sealing.

The conduit 210 is coupled to the hermetic enclosure 400 by a second coupling interface 250. The second coupling interface 250 comprises a fitting 445 that facilitates sealable coupling between the conduit 210 and an opening 450 in the cover 200. The fitting 445 may be a nipple, a union or other plumbing device having an internal cavity formed therein. The fitting 445 may be welded, pressed, or otherwise joined to the cover 200 in a manner that facilitates a hermetic seal.

In one embodiment, the fitting 445 is coupled to the cover 200 by a threaded connection 455. A ferrule 460 may be disposed on the conduit 210 that is adapted to couple to the fitting 445. The threaded connection 455 may include tapered threads that facilitate vacuum sealing at the interface between the fitting 445 and the cover 200 as well as the ferrule 460 and the fitting 445. Alternatively or additionally, one or more seals 320, such as an o-ring or gasket, may be compressed between the ferrule 460, the cover 200 and/or the ferrule 460 and the fitting 445. One or more fastening devices 215, such as clips or straps, may be provided to secure the conduit 210 to the substrate support 120. The fastening devices 215 are coupled to the substrate support 120 by fasteners 205 (shown in FIG. 2A), that may be bolts or screws.

In one embodiment, the substrate support 120 utilized in the vacuum chamber 100 of FIG. 1 may include one or more exterior mounted thermal monitoring assemblies 240. The substrate support 120 may be cleaned before installation of the exterior mounted thermal monitoring assemblies 240. The locations of the exterior mounted thermal monitoring assemblies 240 may be determined and laid out on the bottom surface 124 of the substrate support 120 and the support stem 150. The locations of thermal control devices 170 (shown in FIG. 1) in the substrate support 120 should also be identified to prevent damage to the thermal control devices by machining during the installation procedure. The substrate support 120 may be cleaned after installation. The temperature sensors 175 may be tested and the substrate support 120 may be packaged for transit or installed in a chamber.

In another embodiment, the substrate support 120 may be retrofitted with one or more exterior mounted thermal monitoring assemblies 240. In one aspect the one or more exterior mounted thermal monitoring assemblies 240 comprise a process kit that may be utilized with the substrate support 120 and the vacuum chamber 100 of FIG. 1.

In one embodiment of a retrofit operation, the substrate support 120 may be removed from the chamber body 115. Alternatively, the substrate support 120 may remain in the chamber body 115 if the bottom surface 124 is readily accessible. The substrate support 120 may be cleaned prior to any handling by personnel to remove deposition residue. The locations of the existing temperature probes should be identified to facilitate placement of the to-be-installed temperature sensors 175. The existing temperature probes need not be removed. In one embodiment, the to-be-installed temperature sensors 175 are installed in proximity to the locations of any existing temperature probes. This facilitates temperature measurements in or near the same locations of the substrate support 120, which provides continuity in the temperature measurement and control. The locations of thermal control devices 170 in the substrate support 120 should also be identified to prevent damage to the thermal control devices 170 by machining during the retrofit procedure.

An opening 310 (shown in FIG. 3) may be formed in the support stem 150 for each of the one or more exterior mounted thermal monitoring assemblies 240. The opening 310 may be formed by drilling. The opening 420 may include threads, which are formed by tapping and/or disposing a threaded insert into the opening 310. The threads of the opening 310 are provided to engage the mating threads of the fitting 305.

In the corner regions I-IV of the substrate support 120 (shown in FIG. 2A), an opening 420 (shown in FIG. 4) may be formed for each temperature sensor 175 to be installed. The opening 420 may be a blind hole having a depth and diameter that receives the probe 410. The location of the opening 420 should be proximate to the existing temperature sensor. The opening 420 and mounting holes for securing the mounting portion 415 of the probe 410 may be formed by drilling. Threads may be utilized, if needed, with the opening 420 and/or the mounting hole for the fastener 205 in mounting the probe 410. The threads are formed by tapping and/or disposing a threaded insert into the mounting hole and the opening 420 as needed.

Prior to securing the cover 200 to the substrate support 120, the temperature sensor 175 may be installed by inserting the probe 410 into the opening 420. The mounting portion 415 may be secured to the body 122 of the substrate support 120 by one or more fasteners 205. The cable 230 may be routed through the second coupling interface 250, the conduit 210, the first coupling interface 245, and into the annulus 225 of the support stem 150 to be coupled with the controller 136 outside of the evacuable processing volume 110. The cover 200 and coupling interfaces 245 and 250 may be sealingly coupled such that the environment of the interior volume 405 of the hermetic enclosure 400 is maintained substantially the same as the environment of the annulus 225 of the support stem 150. After installation, the substrate support 120 may be cleaned and re-installed in the chamber body 115.

Embodiments of the exterior mounted thermal monitoring assemblies 240 described herein provide a less expensive and less time intensive approach to installation or replacement of temperature sensors 175 in a substrate support 120. The exterior mounted thermal monitoring assemblies 240 provide a hermetic seal between the environment where the temperature sensor 175 is located and the evacuable processing volume 110 where the substrate support 120 will be used. The exterior mounted thermal monitoring assemblies 240 may be coupled to the substrate support 120 to maintain vacuum integrity of the substrate support 120 and the support stem 150. The exterior mounted thermal monitoring assemblies 240 may be installed without the need for additional bonding or sealing processes, such as soldering. The exterior mounted thermal monitoring assemblies 240 may be prefabricated and readied for an installation or retrofit procedure at a low cost. Thus, installation time and operating costs are minimized, as well as chamber downtime, which increases efficiency and throughput.

While the foregoing is directed to embodiments of the present invention, other and further embodiments of the invention may be devised without departing from the basic scope thereof, and the scope thereof is determined by the claims that follow.

1. A substrate support for a vacuum chamber, the substrate support comprising:
a body having a substrate receiving surface and an opposing bottom surface;
a support stem coupled to and extending away from the bottom surface;
one or more thermal control devices embedded within the body;
at least one temperature sensor interfaced with the bottom surface of the body; and
a removable hermitic enclosure fastened to the second side of the body and covering the at least one temperature sensor.

2. The substrate support of claim 1, further comprising:
a conduit coupling the removable hermetic enclosure to the support stem.

3. The substrate support of claim 2, wherein the conduit is exposed on the bottom surface of the body.

4. The substrate support of claim 3, wherein the conduit is fastened to the bottom surface of the body by one or more mounting straps.

5. The substrate support of claim 2, wherein the conduit is hermetically sealed to the support stem and the removable hermitic enclosure.

6. The substrate support of claim 1, wherein an annulus of the support stem is in fluid communication with an interior volume of the removable hermitic enclosure.

7. The substrate support of claim 2, wherein the conduit comprises an aluminum hose.

8. The substrate support of claim 1, wherein the at least one temperature sensor is disposed at a corner region of the body.

9. A substrate support for a vacuum chamber, the substrate support comprising:
a body having a substrate receiving surface and an opposing bottom surface;
a support stem coupled to and extending away from the bottom surface; and
a plurality of exterior mounted thermal monitoring assemblies disposed on the bottom surface of the body.

10. The substrate support of claim 9, wherein each exterior mounted thermal monitoring assembly comprises:
a removable hermetic enclosure sealing a temperature sensor to the body.

11. The substrate support of claim 10, wherein each exterior mounted thermal monitoring assembly comprises:
a conduit providing fluid communication between an annulus of the support stem and an interior volume of the removable hermetic enclosure.

12. The substrate support of claim 11, wherein the conduit includes a first coupling interface disposed between the support stem and an end of the conduit, the first coupling interface selected from the group consisting of a fused joint or a threaded connection.

13. The substrate support of claim 12, wherein the conduit includes a second coupling interface disposed between the removable hermetic enclosure and an opposing end of the conduit, the second coupling interface selected from the group consisting of a fused joint or a threaded connection.

14. The substrate support of claim 10, wherein each exterior mounted thermal monitoring assembly comprises:
a seal disposed between the removable hermetic enclosure and the second side of the body.

15. A process kit for use in a vacuum chamber, comprising:
one or more temperature probes;
one or more housings adapted to contain at least a portion of one of the one or more temperature probes;
one or more conduits, each of the one or more conduits comprising:
a fitting at a first end thereof; and
a fitting at a second end thereof for coupling to one of the one or more housings; and
one or more straps for coupling to the one or more conduits.

16. The process kit of claim 15, wherein each of the one or more temperature probes comprises a mounting portion.

17. The process kit of claim 15, wherein each of the one or more housings include an o-ring.

18. The process kit of claim 15, wherein the one or more conduits comprise a flexible hose.

19. The process kit of claim 18, wherein the flexible hose comprises a metallic material.

20. The process kit of claim 15, wherein at least one of the fittings comprises threads.
